(19) United States
(12) Patent Application Publication
(10) Pub. No.: US 2015/0086827 A1
(43) Pub. Date: Mar. 26, 2015

(54) BATTERY MODULE HAVING HEAT DISSIPATING ASSEMBLY

(71) Applicant: UER Technology Corporation, Miaoli County (TW)

(72) Inventors: RAY-TANG SUN, Miaoli (TW); TSUNG-HSIEN CHUANG, Miaoli (TW); NIEN-TIEN CHENG, Miaoli (TW); CHIEN-LUNG CHEN, Miaoli (TW)

(73) Assignee: UER TECHNOLOGY CORPORATION, Miaoli County (TW)

(21) Appl. No.: 14/067,974

(22) Filed: Oct. 31, 2013

(30) Foreign Application Priority Data
Sep. 25, 2013 (TW) 102134509

(51) Int. Cl. H01M 10/613

(52) U.S. Cl. CPC H01M 10/5004
USPC 429/120

(57) ABSTRACT

A battery module includes a battery pack and a heat dissipating assembly for dissipating heat generated by the battery pack. The battery pack includes a number of battery cells. The heat dissipating assembly includes a heat dissipating sheet, a heat exchange element, and at least one heat pipe. The heat dissipating sheet is thermally coupled to the battery pack for collecting heat generated by the battery pack. The heat exchange element is fixed on a sidewall of the battery pack. The heat exchange element stores a coolant. The heat pipe is attached to the heat dissipating sheet. One end of each heat pipe is inserted into the heat exchange element to absorb the coolant. The absorbed coolant is evaporated by absorbing heat collected by the heat dissipating sheet.

### BACKGROUND

1. Technical Field

The present disclosure relates to battery modules, and particularly to a battery module having a heat dissipating assembly.

2. Description of Related Art

A battery module is formed by arranging multiple battery cells together. However, during a long operation time of the battery module, the battery module will generate a lot of heat. Nowadays, heat dissipating efficiency of the battery module is still less than satisfactory.

Therefore, it is desirable to provide a battery module that can overcome the above-mentioned limitations.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is an assembled, isometric view of a battery module, according to an exemplary embodiment.

FIG. 2 is an exploded, isometric view of the battery module of FIG. 1.

### DETAILED DESCRIPTION

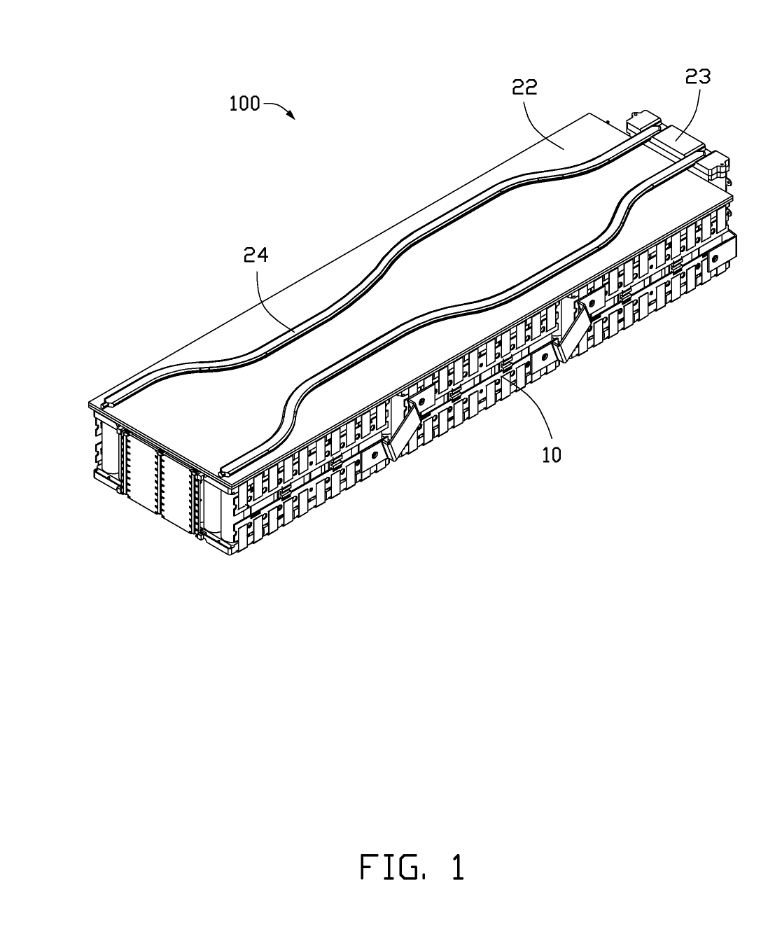

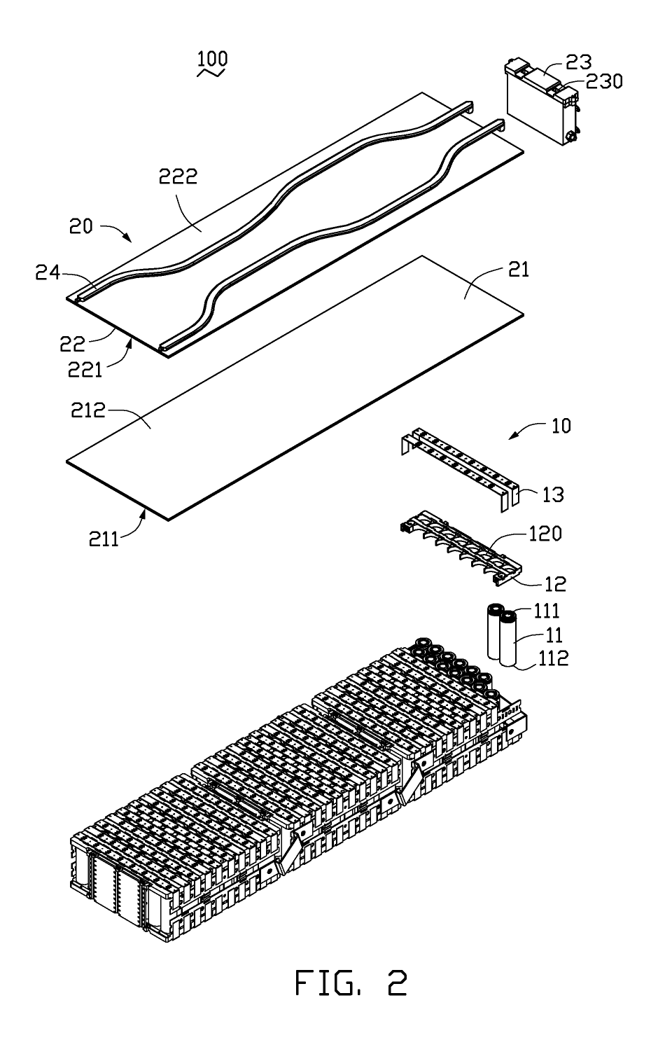

FIGS. 1-2 show a battery module 100 for an electric car (not shown), according to an embodiment. In the illustrated embodiment, the battery module 100 includes a battery pack 10 and a heat dissipating assembly 20 for dissipating heat generated by the battery pack 10.

The battery pack 10 includes a number of battery cells 11 connected in series to increase an output voltage. Each battery cell 11 is substantially cylindrical and includes an anode 111 and a cathode 112. In the embodiment, the battery cell 11 is a lithium battery.

In the embodiment, the battery cells 11 are arranged in rows. The battery pack 10 also includes multiple rows of brackets 12 and a number of conductive pieces 13. The multiple rows of brackets 12 are for holding the battery cells 11. A number of the brackets 12 corresponds to a number of rows of the matrix. In the embodiment, there are thirty rows of battery cells 11. Therefore, the battery pack 10 includes thirty brackets 12. Each bracket 12 defines a number of holding holes 120. Each holding hole 120 spatially corresponds to an anode 111. Each bracket 12 is fastened to a row of battery cells 11, such that each anode 111 is received in a holding hole 120. The brackets 12 are made of insulating material, such as thermal plastic.

A thickness of the anode 111 is slightly larger than a thickness of the holding hole 120. As such, the anode 111 is exposed out of the holding hole 120. Each conductive piece 13 is located on the bracket 12, such that the anode 111 electrically connects to the conductive piece 13. The conductive piece 13 electrically connects the battery cells 11 of the same row in series to increase the output voltage. In the embodiment, the conductive piece 13 is made of copper alloy.

The heat dissipating assembly 20 includes a heat dissipating layer 21, a heat dissipating sheet 22, a heat exchange element 23, and two heat pipes 24.

The heat dissipating layer 21 is substantially rectangular and is positioned on the battery pack 10 for covering the anodes 111, the conductive piece 13, and the brackets 12. The heat dissipating layer 21 includes a first surface 211 facing the battery pack 10, and a second surface 212 facing away from the battery pack 10. In the embodiment, the heat dissipating layer 21 is made of thermal-conducting material, such as silicone rubber.

In the embodiment, the heat dissipating sheet 22 is made of metal, such as copper, aluminum, or aluminum alloy. A shape and a size of the heat dissipating sheet 22 correspond to a shape and a size of the heat dissipating layer 21, respectively. The heat dissipating sheet 22 is positioned on the second surface 212 of the heat dissipating layer 21. The heat dissipating sheet 22 includes a bottom surface 221 contacting the second surface 212, and a supporting surface 222 facing away from the bottom surface 221.

The heat exchange element 23 is fixed on a sidewall of the battery pack 10. The heat exchange element 23 stores coolant. Coolant is chosen according to a temperature at which the heat pipe 24 must operate. In the embodiment, the coolant is an alcohol. The heat exchange element 23 defines two input holes 230.

The heat pipes 24 are tubes and are made of high thermal-conductivity material, such as copper or aluminium, and are attached to the supporting surface 222 of the heat dissipating sheet 22. A number of capillaries are formed on an inner surface of the heat pipe 24. One end of each heat pipe 24 is inserted into the heat exchange element 23 through the two input holes 230. As such, the heat pipes 24 absorb the coolant through capillary action. In the embodiment, the heat pipes 24 are curved to increase a contact area between the heat pipes 24 and the supporting surface 222.

In use, heat generated by the anodes 111 of the battery cells 11 is transferred to the heat dissipating layer 21 through the brackets 12 and the conductive pieces 13, and the heat dissipating sheet 22 collects the heat. The coolant absorbed by the heat pipes 24 is evaporated by absorbing heat from the supporting surface 222. The coolant is then reabsorbed by the heat pipes 24 from the heat exchange element 23 through capillary action, and the cycle repeats. As such, the coolant absorbed by the heat pipes 24 absorbs and removes the heat collected by the heat dissipating sheet 22.

In other embodiments, the heat dissipating sheet 22 can be made of insulating material and be directly positioned on the battery pack 10, such that the heat dissipating layer 21 can be omitted.

In other embodiments, a number of the heat pipes 24 can be changed according to need.

It will be understood that the above particular embodiments are shown and described by way of illustration only. The principles and the features of the present disclosure may be employed in various and numerous embodiment thereof without departing from the scope of the disclosure as claimed. The above-described embodiments illustrate the possible scope of the disclosure but do not restrict the scope of the disclosure.

What is claimed is:

1. A battery module, comprising:
a battery pack comprising a plurality of battery cells;
a heat dissipating assembly for dissipating heat generated by the battery pack, the heat dissipating assembly comprising:
a heat dissipating sheet thermally coupled to the battery pack, for collecting the heat generated by the battery pack;
a heat exchange element fixedly positioned on a sidewall of the battery pack, the heat exchange element storing a coolant; and
at least one heat pipe attached onto the heat dissipating sheet, one end of each heat pipe inserted into the heat exchange element to absorb the coolant, the absorbed coolant evaporated by absorbing heat collected by the heat dissipating sheet.

2. The battery module of claim 1, wherein the heat dissipating sheet is made of an insulating material, and is directly positioned on the battery pack.

3. The battery module of claim 1, wherein the heat dissipating sheet is made of metal, the heat dissipating assembly comprises a heat dissipating layer, the heat dissipating sheet is positioned on the battery pack through the heat dissipating layer.

4. The battery module of claim 3, wherein the heat dissipating layer comprises a first surface facing the battery pack and a second surface facing away from the battery pack, the heat dissipating sheet is positioned on the second surface, the heat dissipating sheet comprises a bottom surface contacting with the second surface and a supporting surface facing away from the bottom surface, the at least one heat pipe is attached to the supporting surface.

5. The battery module of claim 4, wherein a shape and a size of the heat dissipating sheet correspond to a shape and a size of the heat dissipating layer, respectively.

6. The battery module of claim 4, wherein the heat dissipating sheet is made of copper, aluminum, or aluminum alloy.

7. The battery module of claim 4, wherein the heat dissipating layer is made of thermal-conducting material.

8. The battery module of claim 7, wherein the heat dissipating layer is made of silicone rubber.

9. The battery module of claim 1, wherein the coolant is alcohol.

10. The battery module of claim 1, wherein the at least one heat pipes is made of high thermal-conductivity material.

11. The battery module of claim 10, wherein the at least one heat pipe is made of copper or aluminium, the at least one heat pipe comprises a plurality of capillaries formed on an inner surface of each heat pipe.

12. The battery module of claim 1, wherein the at least one heat pipe is curved.

13. The battery module of claim 1, wherein the battery pack comprises a plurality of battery cells connected in series to increase the output voltage, the battery cells are arranged in rows, the battery pack comprises multiple rows of brackets holding the battery cells.

14. The battery module of claim 13, wherein each battery cell comprises an anode and a cathode, a number of the brackets corresponds to a number of row of the battery cells, each bracket defines a plurality of holding holes, each holding holes spatially corresponds to an anode, each bracket is fastened to a row of battery cells, with each anode being held in a respective one of the holding holes.

15. The battery module of claim 14, wherein the battery pack comprises a plurality of conductive pieces, a thickness of the anode is slightly larger than a thickness of the holding hole, each anode is exposed out of a holding hole, each conductive piece is located on the bracket, with the anode being electrically connected to the conductive piece, the conductive piece is configure to electrically connect the battery cells of the same row in series to increase the output voltage.

16. The battery module of claim 13, wherein the brackets are made of insulating material.

17. The battery module of claim 16, wherein the brackets are made of thermal plastic.

18. The battery module of claim 1, wherein the heat exchange element defines at least one input hole, one end of each heat pipe is inserted into the heat exchange element through a respective one of the at least one input hole.

19. The battery module of claim 1, wherein the at least one heat pipe is inserted into the heat exchange element to absorb the coolant through capillary action.
